(19) United States
(12) Patent Application Publication
(10) Pub. No.: US 2024/0413468 A1
(43) Pub. Date: Dec. 12, 2024

(54) BATTERY PACK

(71) Applicant: HONDA MOTOR CO., LTD., Tokyo (JP)

(72) Inventors: Koudai HASEBE, Tokyo (JP); Shinya NAKAYAMA, Tokyo (JP); Takahiro TAKAI, Tokyo (JP); Satoshi TAKADA, Tokyo (JP)

(21) Appl. No.: 18/679,308

(22) Filed: May 30, 2024

(30) Foreign Application Priority Data
Jun. 9, 2023 (JP) 2023-095756

(51) Int. Cl. H01M 50/289; H01M 10/6556; H01M 50/242; H01M 50/249

(52) U.S. Cl. CPC H01M 50/289; H01M 10/6556; H01M 50/242; H01M 50/249

(57) ABSTRACT

A battery pack includes a stacked body in which a plurality of secondary batteries are stacked, a restraint member that extends in a stacked direction of the stacked body along a first surface of the stacked body, and that restrains the plurality of secondary batteries, and a plurality of extrusion materials that are disposed along a second surface of the stacked body in the stacked direction, and that support the stacked body, and each of the plurality of extrusion materials is disposed such that an extrusion direction intersects the stacked direction.

### CROSS-REFERENCE TO RELATED APPLICATION(S)

This application claims priority to and the benefit of Japanese Patent Application No. 2023-095756 filed on Jun. 9, 2023, the entire disclosure of which is incorporated herein by reference.

### BACKGROUND OF THE INVENTION

### Field of the Invention

The present invention relates to a battery pack.

### Description of the Related Art

In order to reduce CO₂ from the viewpoint of climate-related disasters, electrification of industrial machines has been promoted, and study of secondary batteries as energy sources is carried out also for use in vehicles. Such secondary batteries (batteries) are stacked to form a secondary battery group (a battery module), the battery module is mounted in a battery pack housing (a battery pack case), and a battery pack is formed. As such a battery pack, International Publication No. 2019/151036 discloses a battery pack including a battery stacked body including a plurality of rectangular batteries.

The battery pack case includes a structural member such as a cross member or a side frame for the purpose of ensuring strength rigidity and external force resistance performance so as to be coupled with a vehicle. Such a structural member contributes to the strength rigidity in the battery pack case, in a longitudinal direction of the vehicle and a left-and-right direction of the vehicle.

The structural member of the battery pack case, however, has the main purpose of fixing and protecting the battery module. Depending on the structural member, the battery pack case may become larger and heavier, when trying to ensure the strength rigidity of the battery pack. In addition, the structural member of the battery pack case occupies a part of a mount space of the secondary battery. Hence, there is a demand for improving mount efficiency of the secondary battery.

### SUMMARY OF THE INVENTION

According to one embodiment of the present invention, a battery pack is provided in which sufficient strength rigidity is achieved, and in addition, an increase in weight of the battery pack can be suppressed, and mount efficiency of a secondary battery can be improved. In addition, in one embodiment, such a battery pack contributes to energy efficiency.

According to one embodiment of the present invention, a battery pack comprises: a stacked body in which a plurality of secondary batteries are stacked; a restraint member that extends in a stacked direction of the stacked body along a first surface of the stacked body, and that restrains the plurality of secondary batteries; and a plurality of extrusion materials that are disposed along a second surface of the stacked body in the stacked direction, and that support the stacked body, wherein each of the plurality of extrusion materials is disposed such that an extrusion direction intersects the stacked direction.

### BRIEF DESCRIPTION OF THE DRAWINGS

FIG. 1 is a schematic view of a battery pack according to one embodiment;

FIG. 2 is a schematic view of a stacked body in which a plurality of secondary batteries according to one embodiment are stacked;

FIG. 3 is a cross-sectional view taken along line A-A of a secondary battery according to one embodiment;

FIG. 4 is a schematic view of a battery module according to one embodiment;

FIG. 5 is a schematic view of a plurality of battery modules according to one embodiment;

FIG. 6 is another schematic view of the plurality of battery modules according to one embodiment; and

FIG. 7 is a schematic view of the battery modules provided in a battery pack case according to one embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### Battery Pack According to The Present Embodiment

A battery pack according to the present embodiment includes: a stacked body in which a plurality of secondary batteries are stacked; a restraint member that extends in a stacked direction of the stacked body along a first surface of the stacked body, and that restrains the plurality of secondary batteries; and a plurality of extrusion materials that are disposed along a second surface of the stacked body in the stacked direction, and that support the stacked body. Furthermore, each of the extrusion materials is disposed such that its extrusion direction intersects the stacked direction. Accordingly, sufficient strength rigidity is achieved, and in addition, an increase in weight of the battery pack can be suppressed, and the mount efficiency of the secondary battery can be improved.

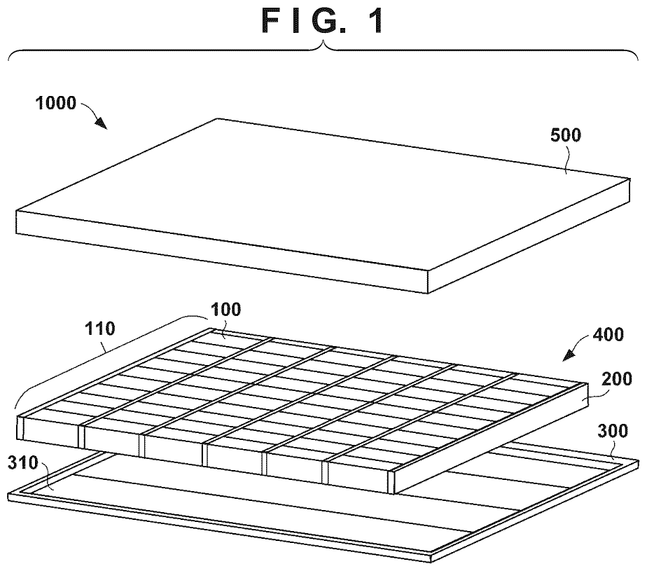

FIG. 1 is a schematic view of a battery pack according to one embodiment. A battery pack 1000 can be mounted on, for example, an electric vehicle such as a hybrid vehicle or an EV, which are not illustrated. The battery pack 1000 includes secondary batteries 100, a restraint member 200, which restrains the secondary batteries 100, a battery pack case 300, an extrusion material 310, which is provided in the battery pack case 300, and which supports the secondary batteries 100, and a battery pack cover 500, which covers the secondary batteries 100.

The plurality of secondary batteries 100 are stacked to constitute a stacked body 110. The stacked body 110 is restrained by the restraint member 200, which extends in a stacked direction along a first surface of the stacked body 110. A battery module 400 is formed of the stacked body 110 and the restraint member 200. A plurality of battery modules 400 are stacked in a direction that intersects the stacked direction of the stacked body 110.

In FIG. 1, the plurality of battery modules 400 are illustrated to be separated from the battery pack case 300 and the battery pack cover 500. However, the plurality of battery modules 400 are supported by the extrusion material 310, which is provided in the battery pack case 300, and are covered with the battery pack cover 500, and the battery pack 1000 is formed. In addition, a plurality of extrusion materials 310 are provided in the battery pack case 300, and are disposed such that the extrusion directions intersect the stacked direction of the stacked body 110. Hereinafter, each configuration of the battery pack 1000 will be sequentially described.

### Secondary Battery

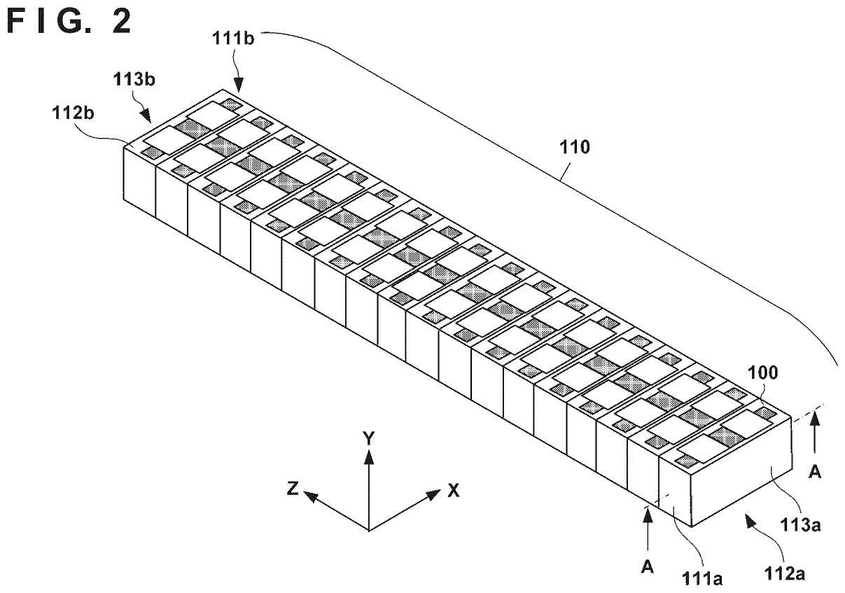

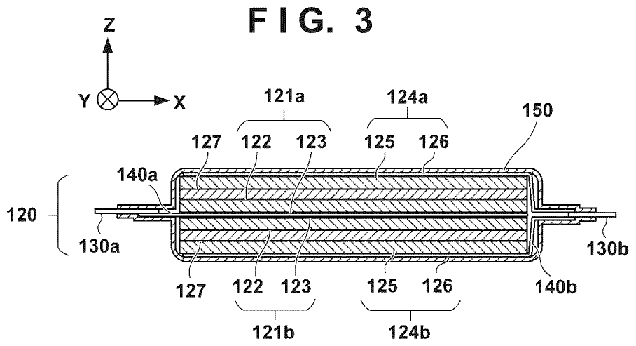

FIG. 2 is a schematic view of a stacked body in which a plurality of secondary batteries according to one embodiment are stacked. FIG. 3 is a schematic cross-sectional view taken along line A-A of the secondary battery according to one embodiment. In the secondary battery 100, the configuration of the secondary battery illustrated in FIG. 3 is disposed in an exterior body. As illustrated in FIG. 2, the external appearance shape of the secondary battery 100 is a substantially rectangular parallelepiped one.

As illustrated in FIG. 2, the plurality of secondary batteries 100 are stacked in a thickness direction (Z direction) of a constituent element 120 of the secondary battery 100, and the stacked body 110 (a battery group) is formed. In addition, the secondary battery 100, while being disposed in an upright attitude, can be stacked in Z direction alternately with a separator (not illustrated) having an insulation property. The stacked body 110 is obtained by stacking the secondary batteries 100, each having a rectangular parallelepiped shape, in Z direction, and its external appearance shape is a rectangular parallelepiped one as a whole.

The number of the secondary batteries 100 in the stacked body 110 is not particularly limited, may be equal to or more than five in one embodiment, equal to or more than ten in another embodiment, equal to or more than 20 in still another embodiment, equal to or more than 40 in still another embodiment, and may be equal to or less than 100 in one embodiment, equal to or less than 90 in another embodiment, equal to or less than 80 in still another embodiment, and equal to or less than 60 in still another embodiment.

The stacked body 110 includes a first surface 111a (YZ surface) when viewed from a longitudinal direction (X direction) of the secondary battery 100, a second surface 112a (XZ surface) when viewed from a width direction (Y direction) of the secondary battery 100, and a third surface 113a (XY surface) when viewed from a thickness direction (Z direction) of the constituent element 120 of the secondary battery 100. Note that the stacked body 110 also includes a first surface 111b, a second surface 112b, and a third surface 113b, which are respectively opposite to the first surface 111a, the second surface 112a, and the third surface 113a, and has similar shapes and dimensions as those of the respective opposite surfaces.

In the constituent element 120 of the secondary battery 100 illustrated in FIG. 3, X direction indicates an extending direction of a lead terminal, Y direction indicates a direction orthogonal to the extending direction of the lead terminal, Z direction indicates a laminated direction of the constituent element 120 of the secondary battery 100, and X direction, Y direction, and Z direction are orthogonal to one another.

The configuration of the secondary battery includes the constituent element 120 of the secondary battery, lead terminals 130, current collection terminals 140, and an exterior body 150, which encloses the constituent element 120, and has a form of a battery cell suitable for an assembled battery. The constituent element 120 has a rectangular parallelepiped shape as a whole, and as illustrated in FIG. 3, includes two layers of positive electrode layers 121a and 121b, and two layers of negative electrode layers 124a and 124b in a two-layered structure of the positive electrode layers and the negative electrode layers. However, as the constituent element 120, the positive electrode layer and the negative electrode layer may form one layer or three or more layers. Solid electrolyte layers 127 are respectively provided between the positive electrode layer 121a and the negative electrode layer 124a and between the positive electrode layer 121b and the negative electrode layer 124b.

Each of the positive electrode layers 121a and 121b includes a positive electrode active material layer 122. In addition, a positive electrode current collector 123, which is common to the two positive electrode layers 121a and 121b, is included. The positive electrode current collector 123 is disposed in a layer form at the center of the constituent element 120 in Z direction, and the positive electrode active material layers are respectively laminated on the front and back sides.

The negative electrode layers 124a and 124b are respectively disposed on an outer side in one direction and an outer side in the other direction in Z direction with respect to the positive electrode layers 121a and 121b, and are laminated such that the negative electrode layers 124a and 124b sandwich the positive electrode layers 121a and 121b. However, contrary to the configuration in the present embodiment, it is also possible to adopt a configuration in which those layers are laminated such that the two positive electrode layers sandwich the two negative electrode layers. The negative electrode layers 124a and 124b each include a negative electrode active material layer 125 and a negative electrode current collector 126. The two negative electrode current collectors 126 are each formed in a layer form at an outermost layer of the constituent element 120.

Examples of the active material that constitutes the positive electrode active material layer 122 include lithium cobalt oxide, lithium nickel oxide, lithium manganese oxide, and lithium metal phosphate. In addition, examples of the active material that constitutes the negative electrode active material layer 125 include a lithium-based material, a silicon-based material, and the like. Examples of the lithium-based material include Li metal and Li alloy. Examples of the silicon-based material include Si and SiO. Other examples of the active material that constitutes the negative electrode active material layer 125 include carbon materials such as graphite, soft carbon, and hard carbon, tin-based materials (Sn, SnO, and the like), and lithium titanate.

The electrolyte layer 127 includes, for example, a solid, gel, or liquid electrolyte having ion conductivity, and examples of the material include a sulfide-based solid electrolyte material, an oxide-based solid electrolyte material, a nitride-based solid electrolyte material, a halide-based solid electrolyte material, a lithium-containing salt, and a gel material containing a lithium ion conductive ionic liquid. The positive electrode current collector 123 and the negative electrode current collector 126 are formed of, for example, a metal foil, a metal sheet, or a metal plate of aluminum, copper, SUS, or the like. The positive electrode active material layer 122, the negative electrode active material layer 125, and the electrolyte layer 127 may be formed by bonding particles of substances that constitute these layers with an organic polymer compound-based binder. In one embodiment, the secondary battery 100 may be an all-solid-state battery.

The lead terminals 130a and 130b are connected with a charger or an electric load to charge or discharge the constituent element 120. One end portions of the lead terminals 130a and 130b are located outside the exterior body 150, and the other end portions are located inside the exterior body 150.

The other end portions of the lead terminals 130a and 130b are connected with the positive electrode current collector 123 through the current collection terminal 140a inside the exterior body 150, and the lead terminal 130a forms a terminal for a positive electrode. The lead terminal 130b and the current collection terminal 140b are each formed of, for example, a conductive metal sheet or a metal plate. On the other hand, the other end portion of the lead terminal 130b is connected with the negative electrode current collector 126 through the current collection terminal 140b inside the exterior body 150, and the lead terminal 130b forms a terminal for a negative electrode. The lead terminal 130b and the current collection terminal 140b are each formed of, for example, a conductive metal sheet or a metal plate.

The arrangement of the lead terminals 130a and 130b are not particularly limited. The lead terminals 130a and 130b may be disposed at both ends in the longitudinal direction (X direction) of the secondary battery 100, or may be disposed at one end (disposed above) in the width direction (Y direction) of the secondary battery 100.

### Battery Module

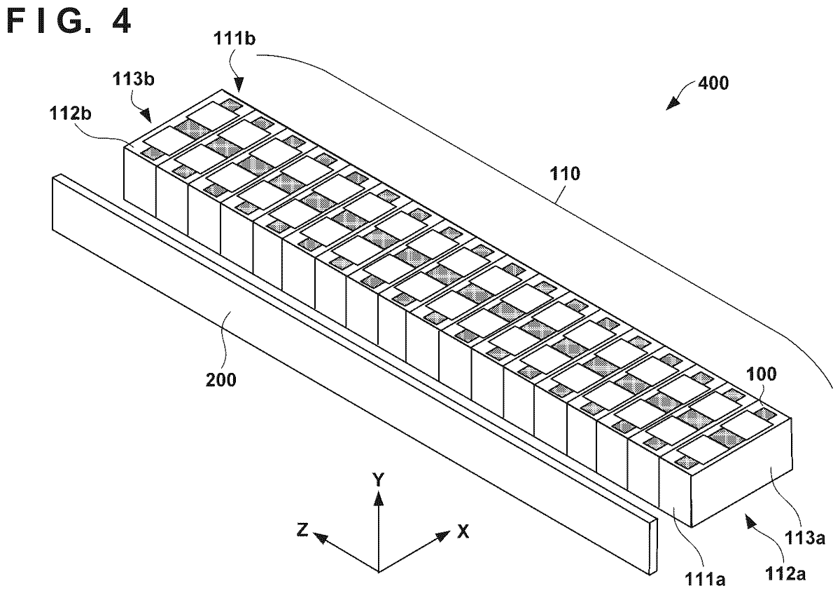

FIG. 4 is a schematic view of a battery module according to one embodiment. The battery module 400 includes the stacked body 110 in which a plurality of secondary batteries 100 are stacked, and the restraint member 200, which restrains the plurality of secondary batteries 100. The external appearance shape of the battery module 400 is a rectangular parallelepiped one.

### Restraint Member

The restraint member 200 extends in the stacked direction (Z direction) of the stacked body 110 along the first surface 111a of the stacked body 110. In one embodiment, the restraint member 200 extends in the stacked direction (Z direction) of the stacked body 110 so as to cover the entirety of the first surface 111a of the stacked body 110. In FIG. 4, the stacked body 110 and the restraint member 200 are separated from each other, but the stacked body 110 is joined with the restraint member 200. This enables sufficient strength rigidity to be given to the battery pack, and in particular, the sufficient strength rigidity to be given in the stacked direction of the stacked body 110.

The material of the restraint member 200 is not particularly limited, as long as it is capable of giving the sufficient strength rigidity to the battery pack, but may be a metal sheet or a metal plate of aluminum, copper, SUS, or the like.

The shape of the restraint member 200 is not particularly limited, as long as it is capable of restraining the plurality of secondary batteries 100. In one embodiment, the surface of the restraint member 200 when viewed from the thickness direction (X direction) can have a rectangular shape, a trapezoidal shape, a parallelogram shape, or the like. In addition, the length in the width direction (Y direction) when viewed in the thickness direction (X direction) of the restraint member 200 may be constant or partially different along the longitudinal direction (Z direction) of the restraint member 200. Further, the thickness (the length in X direction) of the restraint member 200 may be constant or partially different along the longitudinal direction of the restraint member 200. This enables the plurality of secondary batteries 100 to be sufficiently restrained.

The lower limit of the thickness (the length in X direction) of the restraint member 200 is not particularly limited, but may be equal to or more than 1 mm in one embodiment, equal to or more than 2 mm in another embodiment, and equal to or more than 5 mm in still another embodiment, at the thinnest part. This enables sufficient strength rigidity to be given to the battery pack. In addition, the upper limit of the thickness (the length in X direction) of the restraint member 200 is not particularly limited, but may be equal to or less than 20 mm in one embodiment, equal to or less than 10 mm in another embodiment, and equal to or less than 7 mm in still another embodiment, at the thinnest part. This increases the space in which the secondary battery 100 can be mounted.

Further, the restraint member 200 may be formed such that one end portion or both end portions in the width direction (Y direction) of the restraint member 200 cover a part of the stacked body 110. For example, the restraint member 200 can have a shape in which a surface viewed from Z direction has a letter I shape or a letter U shape.

The restraint member 200 is joined with the stacked body 110, and its joining method is not particularly limited. However, as an example, an adhesive is filled for joining between the first surface 111a of the stacked body 110 and the restraint member 200. The adhesive is not particularly limited, and its examples include an acrylic resin, a urethane-based resin, a silicone-based resin, an epoxy-based resin, and an olefin-based resin. In addition, a separator (not illustrated) having an insulation property may be disposed between the restraint member 200 and the stacked body 110.

### Battery Module Group

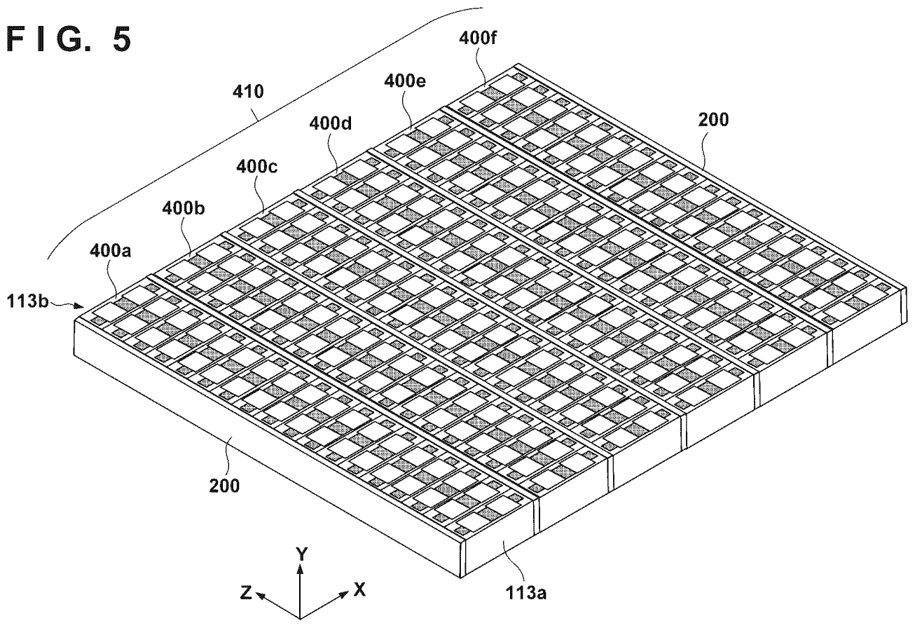

FIG. 5 is a schematic view of a plurality of battery modules according to one embodiment. A plurality of battery modules 400a to 400f are disposed in the longitudinal direction (X direction) of the secondary battery 100 along the third surface 113a of the stacked body 110, and a battery module group 410 is formed. In addition, in FIG. 5, the battery module group 410 is formed of six battery modules 400, but the number of them is not particularly limited.

Further, the battery module 400f, which is located on an end of the battery module group 410, includes two restraint members 200 along the first surfaces 111a and 111b of the stacked body 110, and those restraint members 200 are disposed to face each other. In other words, the plurality of battery modules 400a to 400f are disposed in a direction that intersects the longitudinal direction of the restraint member 200, and the respective restraint members 200 are disposed to face each other. Accordingly, the battery module 400 and the restraint member 200 are alternately disposed in X direction, and each battery module 400 is sandwiched between the restraint members 200.

In addition, it is possible to join the battery module 400 with the restraint member 200 of an adjacent battery module 400. Accordingly, it can be also said that the battery module group 410 serves as a large-sized battery module capable of fulfilling high strength rigidity. Further, the joining method is not particularly limited, and as an example, an adhesive is filled for joining between the first surface 111b of the stacked body 110 of the battery module 400 and the restraint member 200 of an adjacent battery module 400. As the adhesive, it is possible to use the above-described ones.

In this manner, the battery modules 400 are joined by the restraint member 200. Therefore, the battery pack 1000 according to the present embodiment is capable of eliminating the need for a structural member, such as a cross member of the battery pack case 300, to be provided mainly for fixing and protecting the battery module 400. In other words, in the battery pack 1000 according to the present embodiment, ensuring the strength rigidity and the external force resistance performance of the battery pack case 300 and the holding structure of the secondary battery 100, which have been functioned by the structural member such as the cross member of the battery pack case 300, are integrated into the restraint member 200. Accordingly, the battery module 400 having sufficient strength rigidity is achieved, and a weight reduction of the battery pack case 300 is enabled. In addition, the space for installing the secondary battery 100 increases, and thus the mount efficiency of the secondary battery 100 is improved.

### End Plate

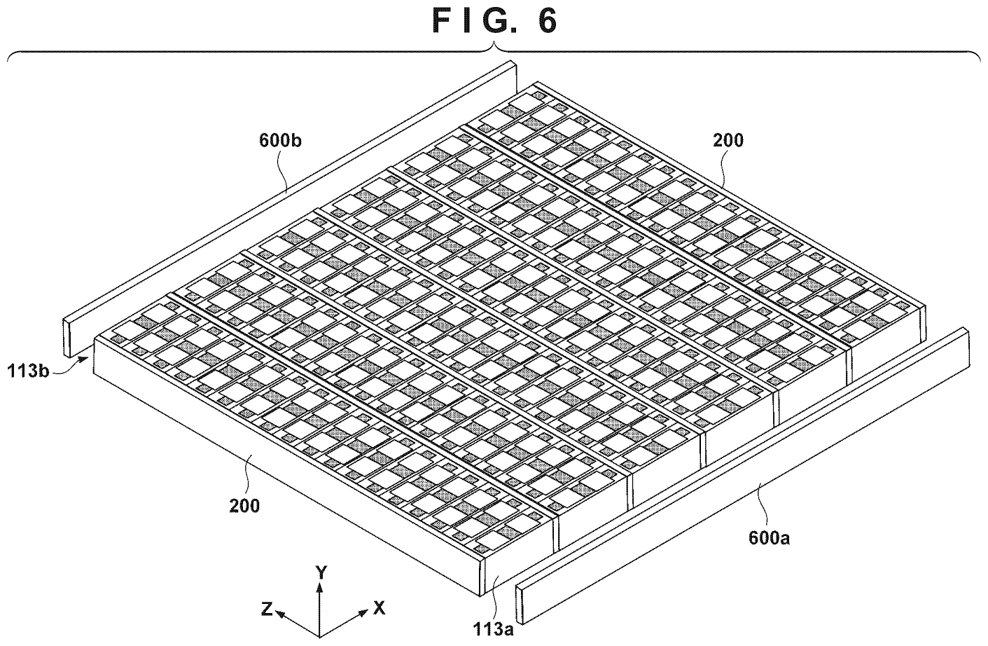

FIG. 6 is another schematic view of a plurality of battery modules according to one embodiment. The battery module group 410 can include end plates 600a and 600b, which respectively extend along the third surfaces 113a and 113b of the stacked body 110 in a disposed direction (X direction) of the plurality of battery modules 400. In other words, the longitudinal direction of the end plates 600a and 600b is a direction that intersects the longitudinal direction of the restraint member 200. This further enables sufficient strength rigidity to be given to the battery pack.

In FIG. 6, the stacked bodies 110 and the restraint member 200 are illustrated to be separated from the end plates 600a and 600b, but the stacked bodies 110 and the restraint member 200 are coupled with the end plates 600a and 600b. Its coupling method is not particularly limited, and a known technique is appropriately applicable.

In addition, in FIG. 6, one end plate 600a and one end plate 600b are respectively provided on the third surfaces 113a and 113b of the stacked body 110. However, a plurality of end plates 600a and a plurality of end plates 600b may be respectively provided on the third surfaces 113a and 113b of the stacked bodies 110. For example, the plurality of end plates 600a and the plurality of end plates 600b, each having a length that couples adjacent battery modules 400 in the longitudinal direction (X direction), may be respectively provided on the third surfaces 113a and 113b of the stacked bodies 110. This facilitates assembling the battery module group 410.

The material of the end plates 600a and 600b is not particularly limited, as long as it is capable of giving sufficient strength rigidity to the battery pack, but may be a metal sheet or a metal plate of aluminum, copper, SUS, or the like.

In one embodiment, in the end plates 600a and 600b, holes are formed to enable fastening bolts to penetrate through for fixing the battery module 400 to the battery pack case 300. A pair of female screw portions, into which a pair of fastening bolts are respectively screwed, are formed in the battery pack case 300.

### Extrusion Material

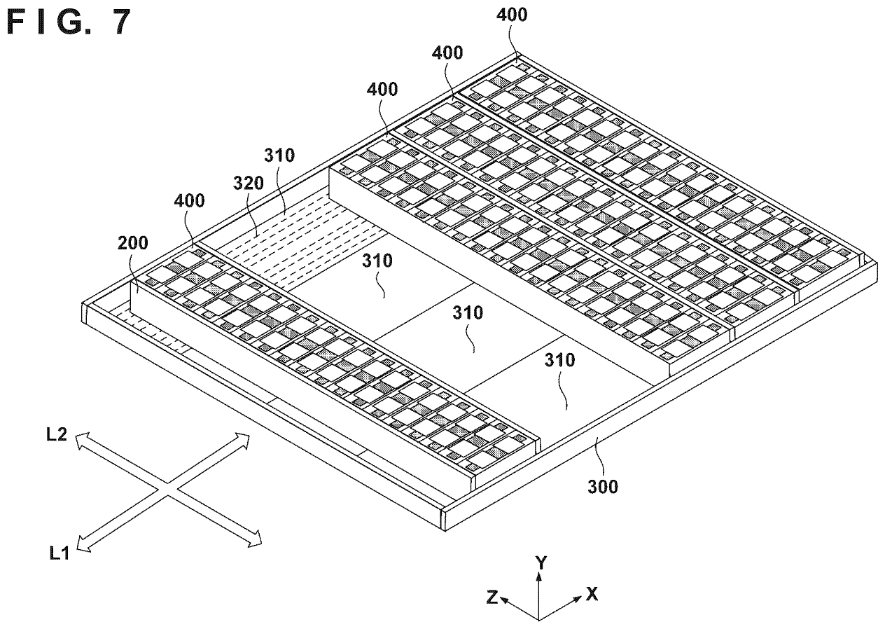

FIG. 7 is a schematic view of battery modules provided in a battery pack case according to one embodiment. In FIG. 7, some of the battery modules 400 are removed in order to facilitate understanding of the arrangement relationship between the extrusion material 310 and the stacked body 110 and the structure of the extrusion material 310. That is, the battery modules 400 can be disposed to cover substantially the entire bottom surface of the battery pack case 300.

The battery modules 400 are provided such that the stacked bodies 110 are supported by the extrusion materials 310, which are provided in the battery pack case 300. In one embodiment, the battery modules 400 can be provided such that the stacked bodies 110 are placed on the extrusion materials 310. In addition, the battery modules 400 may be provided such that all the stacked bodies 110 are placed on the extrusion materials 310, or may be provided such that some of the stacked bodies 110 are placed on the extrusion materials 310.

A plurality of the extrusion materials 310 are disposed in the stacked direction along the second surfaces 112b of the stacked bodies 110. It is possible to determine the number of the extrusion materials 310 in accordance with the dimensions, the strength rigidity, and the like of the battery pack, without being particularly limited. However, the number of the extrusion materials 310 can be equal to or more than two in one embodiment, equal to or more than four in another embodiment, equal to or more than six in still another embodiment, and equal to or more than eight in still another embodiment, and can be equal to or less than 20 in one embodiment, equal to or less than 18 in another embodiment, equal to or less than 16 in still another embodiment, and equal to or less than 14 in still another embodiment. In addition, the extrusion materials 310 may be provided on the bottom surface of the battery pack case 300 of tray type, or may be provided to constitute the bottom surface of the battery pack case 300 of tray type.

The extrusion material 310 according to the present embodiment is obtained by extrusion machining. The longitudinal direction of the extrusion material 310 substantially coincides with the extrusion direction (X direction). The bending rigidity of the extrusion material in the extrusion direction tends to be higher than the bending rigidity in the direction perpendicular to the extrusion direction. In the present embodiment, each of the extrusion materials 310 is disposed such that its extrusion direction intersects the stacked direction of the stacked body 110. In one embodiment, each of the extrusion materials 310 can be disposed such that its extrusion direction is orthogonal to the stacked direction of the stacked body 110.

As described above, the restraint member 200 extends and is joined in the stacked direction (Z direction) of the stacked body 110, so that sufficient strength rigidity can be given to the battery pack with respect to the stacked direction of the stacked body 110. On the other hand, the extrusion material 310 is disposed such that its extrusion direction is the direction (X direction) that intersects the stacked direction (Z direction) of the stacked body 110, so that sufficient strength rigidity can be given to the battery pack with respect to the direction that intersects the stacked direction of the stacked body 110.

In this manner, the battery pack 1000 according to the present embodiment includes the extrusion material 310 capable of giving the strength rigidity, in addition to the restraint member 200, which is provided in the battery module 400. Therefore, the battery pack 1000 according to the present embodiment is capable of eliminating the need for a structural member such as a cross member or a side frame for ensuring the strength rigidity and the external force resistance performance of the battery pack case 300. In the battery pack 1000 according to the present embodiment, the restraint member 200 and the extrusion material 310 are functioned to ensure the strength rigidity and the external force resistance performance of the battery pack case 300 and the holding structure of the secondary battery 100, which have been functioned by the structural member such as the cross member or the side frame of the battery pack case 300. Accordingly, the battery module 400 having sufficient strength rigidity is achieved, and a weight reduction of the battery pack case 300 is enabled. In addition, the space for installing the secondary battery 100 increases, and thus the mount efficiency of the secondary battery 100 is improved.

In one embodiment, the battery pack 1000 according to the present embodiment can be mounted on a vehicle, so that the battery pack 1000 can be disposed such that the direction that intersects the stacked direction of the stacked body 110 faces a longitudinal direction L1 of the vehicle. That is, the battery pack 1000 is disposed such that the extrusion direction of the extrusion material 310 substantially coincides with the longitudinal direction L1 of the vehicle, and the stacked direction of the stacked body 110 (the longitudinal direction of the restraint member 200) substantially coincides with a left-and-right direction L2 of the vehicle. Accordingly, in a case where the battery pack 1000 is mounted on the vehicle, sufficient strength rigidity can be given to the battery pack 1000 in two different directions.

In another embodiment, the extrusion material 310 may include a fluid passage 320, the inside of which a heat medium passes through. The fluid passage 320 extends along the extrusion direction of the extrusion material 310, and can be formed when the extrusion material 310 is subject to extrusion machining. This enables the battery module 400 to be heated and cooled efficiently. In FIG. 7, one extrusion material 310 is illustrated to include the fluid passage 320. However, the fluid passage 320 may be provided in all of the extrusion materials 310 or in some of the extrusion materials 310.

As illustrated in FIG. 7, the secondary battery 100 is disposed such that a predetermined surface (a bottom surface) of the secondary battery 100 faces the extrusion materials 310, and heat of the secondary battery 100 is transferred to the extrusion materials 310, or heat of the extrusion materials 310 is transferred to the secondary battery 100. This enables the secondary battery 100 to be cooled and heated. The heat medium that passes through the fluid passage 320 is not particularly limited, as long as it can be heated or cooled. The heat medium may be a gas medium, a liquid medium, or a traveling wind while the vehicle is traveling. Any other known technique is appropriately applicable.

### Summary of Embodiments

The above embodiments disclose at least the following battery pack.
1. A battery pack (1000) according to the above embodiment comprises:
a stacked body (110) in which a plurality of secondary batteries (100) are stacked;
a restraint member (200) that extends in a stacked direction of the stacked body (110) along a first surface (111a) of the stacked body (110), and that restrains the plurality of secondary batteries (100; and
a plurality of extrusion materials (310) that are disposed along a second surface (112a) of the stacked body (110) in the stacked direction, and that support the stacked body (110), wherein
each of the plurality of extrusion materials (310) is disposed such that an extrusion direction intersects the stacked direction.

According to this embodiment, sufficient strength rigidity can be given to the battery pack, and in addition, an increase in weight of the battery pack can be suppressed, and the mount efficiency of the secondary battery can be improved.
2. In the above embodiment,
the stacked body (110) is joined with the restraint member (200).

According to this embodiment, sufficient strength rigidity can be given to the battery module.
3. In the above embodiment,
the stacked body (110) is placed on the plurality of extrusion materials (310).

According to this embodiment, sufficient strength rigidity can be given to the battery module, and the battery pack can be heated and cooled efficiently.
4. In the above embodiment,
a plurality of the stacked body (110) and a plurality of the restraint members (200) are disposed in a direction that intersects the stacked direction, and
the plurality of the restraint members (200) are respectively disposed to face each other.

According to this embodiment, sufficient strength rigidity can be given to the battery module, an increase in weight of the battery pack can be suppressed, and the mount efficiency of the secondary battery can be improved.
5. In the above embodiment,
at least one of the plurality of extrusion materials (310) includes a fluid passage (320) through which a heat medium passes, and the fluid passage (320) extends in the extrusion direction.

According to this embodiment, the battery pack can be heated and cooled efficiently.
6. In the above embodiment,
the battery pack (1000) is configured to be mounted on a vehicle, and
the battery pack (1000) is disposed such that a direction that intersects the stacked direction faces a longitudinal direction of the vehicle.

According to this embodiment, sufficient strength rigidity can be given to the battery module in the longitudinal direction of the vehicle and the left-and-right direction of the vehicle.

The invention is not limited to the foregoing embodiments, and various variations/changes are possible within the spirit of the invention.

What is claimed is:

1. A battery pack comprising:
a stacked body in which a plurality of secondary batteries are stacked;
a restraint member that extends in a stacked direction of the stacked body along a first surface of the stacked body, and that restrains the plurality of secondary batteries; and
a plurality of extrusion materials that are disposed along a second surface of the stacked body in the stacked direction, and that support the stacked body, wherein
each of the plurality of extrusion materials is disposed such that an extrusion direction intersects the stacked direction.

2. The battery pack according to claim 1, wherein the stacked body is joined with the restraint member.

3. The battery pack according to claim 1, wherein the stacked body is placed on the plurality of extrusion materials.

4. The battery pack according to claim 1, wherein
a plurality of the stacked body and a plurality of the restraint members are disposed in a direction that intersects the stacked direction, and
the plurality of the restraint members are respectively disposed to face each other.

5. The battery pack according to claim 1, wherein at least one of the plurality of extrusion materials includes a fluid passage through which a heat medium passes, and the fluid passage extends in the extrusion direction.

6. The battery pack according to claim 1, wherein
the battery pack is configured to be mounted on a vehicle, and
the battery pack is disposed such that a direction that intersects the stacked direction faces a longitudinal direction of the vehicle.
